(19) United States
(12) Patent Application Publication
(10) Pub. No.: US 2021/0255734 A1
(43) Pub. Date: Aug. 19, 2021

(54) FLEXIBLE TOUCH SCREEN AND MANUFACTURING METHOD THEREOF

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Taofeng XIE, Beijing (CN); Xiaoyue HE, Beijing (CN)

(21) Appl. No.: 16/305,500

(22) PCT Filed: Apr. 4, 2018
(86) PCT No.: PCT/CN2018/081861

§ 371 Date: Nov. 29, 2018

(30) Foreign Application Priority Data
Jun. 28, 2017 (CN) 201710510277.2

(51) Int. Cl. G06F 3/044

(52) U.S. Cl. CPC G06F 3/0445; G06F 2203/04102; G06F 2203/04112; G06F 2203/04107; G06F 2203/04103

(57) ABSTRACT

A flexible touch screen and a manufacturing method which comprises forming patterns of a first and second touch electrode and a first and second connection line on a flexible substrate. The second touch electrode and the first touch electrode forming a capacitive touch structure. The method further comprises forming a pattern of a first and second wiring of a flexible circuit board located on the flexible substrate. The first touch electrode being electrically connected to the first wiring of the flexible circuit board via the first connection line, and the second touch electrode being electrically connected to the second wiring of the flexible circuit board via the second connection line.

### RELATED APPLICATION

The present application is the U.S. national phase entry of PCT/CN2018/081861, with an international filling date of Apr. 4, 2018, which claims the benefit of Chinese Patent Application No. 201710510277.2, filed on Jun. 28, 2017, the entire disclosure of which is incorporated herein by reference.

### TECHNICAL FIELD

The present disclosure relates to the field of touch technologies, and particularly to a flexible touch screen and a manufacturing method thereof.

### BACKGROUND

A touch screen, also called a “touch panel”, is an inductive display device that can receive input signals such as touch or pressing. When a graphic button on the screen is touched, the touch feedback system in the screen can drive various electronic components in the panel to perform corresponding functions according to a pre-programmed program, thus the touch screen can be used to replace the mechanical button panel, and create a vivid audio video effect by means of displayed images. The touch screen provides a most simple, convenient and natural way of human-computer interaction. It gives multimedia a new look and creates a new and attractive multimedia interactive device. At present, the touch screen can be applied to public information inquiry, office, industrial control, military command, electronic games, ordering, multimedia teaching, real estate presale, and many other fields.

### SUMMARY

A manufacturing method for a flexible touch screen provided by an embodiment of the present disclosure comprises: forming, on a flexible substrate, patterns of a first touch electrode and a first connection line, and patterns of a second touch electrode and a second connection line, the second touch electrode and the first touch electrode forming a capacitive touch structure. The method further comprises: forming a pattern of a first wiring of a flexible circuit board on the flexible substrate, and forming a pattern of a second wiring of the flexible circuit board on the flexible substrate. The first touch electrode is electrically connected to the first wiring of the flexible circuit board via the first connection line, and the second touch electrode is electrically connected to the second wiring of the flexible circuit board via the second connection line, so as to achieve signal transmission between the touch structure and a circuit in the flexible circuit board.

In some exemplary embodiments, the first touch electrode, the first connection line and the first wiring of the flexible circuit board are formed on the flexible substrate by the same patterning process, wherein the first touch electrode, the first connection line and the first wiring of the flexible circuit board are integrated.

In some exemplary embodiments, forming, on a flexible substrate, patterns of a first touch electrode and a first connection line and patterns of a second touch electrode and a second connection line includes: forming patterns of the first touch electrode and the first connection line on a side of the flexible substrate; forming a first insulating layer covering the patterns of the first touch electrode and the first connection line, and forming the patterns of the second touch electrode and the second connection line on the first insulating layer. And during a patterning process for forming the patterns of the second touch electrode and the second connection line, the pattern of the second wiring of the flexible circuit board is formed on the flexible substrate simultaneously, wherein the second touch electrode, the second connection line and the second wiring of the flexible circuit board are integrated.

In some exemplary embodiments, the method further comprises: forming a second insulating layer covering the pattern of the first wiring of the flexible circuit board, the patterns of the second touch electrode and the second connection line, and the pattern of the second wiring of the flexible circuit board, and forming a first electrostatic shielding layer on the second insulating layer, an orthographic projection of the first electrostatic shielding layer on the flexible substrate covering the pattern of the first wiring of the flexible circuit board and the pattern of the second wiring of the flexible circuit board.

In some exemplary embodiments, forming, on a flexible substrate, patterns of a first touch electrode and a first connection line and patterns of a second touch electrode and a second connection line includes: forming the patterns of the first touch electrode and the first connection line, and the pattern of the first wiring of the flexible circuit board on a first side of the flexible substrate, and forming the patterns of the second touch electrode and the second connection line on a second side of the flexible substrate opposite to the first side. The method further comprises: forming the pattern of the second wiring of the flexible circuit board on the first side of the flexible substrate, and forming a via hole in the flexible substrate to achieve an electrical connection between the second touch electrode, the second connection line and the second wiring of the flexible circuit board.

In some exemplary embodiments, the method further comprises: forming a third insulating layer, the third insulating layer covering the patterns of the first touch electrode and the first connection line, the pattern of the first wiring of the flexible circuit board, and the pattern of the second wiring of the flexible circuit board; forming a fourth insulating layer, the fourth insulating layer covering the patterns of the second touch electrode and the second connection line; and forming a second electrostatic shielding layer on the third insulating layer, an orthographic projection of the second electrostatic shielding layer on the flexible substrate covering the pattern of the first wiring of the flexible circuit board and the pattern of the second wiring of the flexible circuit board.

In some exemplary embodiments, the first wiring of the flexible circuit board and the second wiring of the flexible circuit board are located in a same layer.

In some exemplary embodiments, the pattern of the first wiring of the flexible circuit board is shielded during a process of forming the pattern of the second wiring of the flexible circuit board.

In some exemplary embodiments, each of the first touch electrode and the second touch electrode has a metal mesh structure.

In some exemplary embodiments, a material of the metal mesh structure includes copper or silver.

Another exemplary embodiment of the disclosure provides a flexible touch screen, which comprises a flexible substrate, a first touch electrode, a first connection line, and a first wiring of a flexible circuit board on the flexible substrate; a second touch electrode, a second connection line, and a second wiring of the flexible circuit board on the flexible substrate. The second touch electrode and the first touch electrode form a capacitive touch structure. The first touch electrode is electrically connected to the first wiring of the flexible circuit board via the first connection line, and the second touch electrode is electrically connected to the second wiring of the flexible circuit board via the second connection line, so as to achieve signal transmission between the touch structure and a circuit in the flexible circuit board.

In some exemplary embodiments, the first touch electrode, the first connection line, and the first wiring of the flexible circuit board are integrated.

In some exemplary embodiments, the second touch electrode, the second connection line, the first touch electrode, the first connection line, the first wiring of the flexible circuit board, and the second wiring of the flexible circuit board are located on a same side of the flexible substrate. The second touch electrode, the second connection line, and the second wiring of the flexible circuit board are integrated.

In some exemplary embodiments, the flexible touch screen further comprises: a first insulating layer, the first insulating layer isolating the second touch electrode from the first touch electrode, and isolating the first connection line from the second connection line; a second insulating layer covering the first wiring of the flexible circuit board, the second touch electrode, the second connection line, and the second wiring of the flexible circuit board, and a first electrostatic shielding layer on the second insulating layer; an orthographic projection of the first electrostatic shielding layer on the flexible substrate covering the first wiring of the flexible circuit board and the second wiring of the flexible circuit board.

In some exemplary embodiments, the first touch electrode, the first connection line, the first wiring of the flexible circuit board, and the second wiring of the flexible circuit board are located on a first side of the flexible substrate, and the second touch electrode and the second connection line are located on a second side of the flexible substrate opposite to the first side. The flexible touch screen further comprises a via hole in the flexible substrate for achieving an electrical connection between the second touch electrode, the second connection line, and the second wiring of the flexible circuit board.

In some exemplary embodiments, the flexible touch screen further comprises: a third insulating layer covering the first touch electrode, the first connection line, the first wiring of the flexible circuit board, and the second wiring of the flexible circuit board; a fourth insulating layer covering the second touch electrode and the second connection line; a second electrostatic shielding layer on the third insulating layer, an orthographic projection of the second electrostatic shielding layer on the flexible substrate covering the first wiring of the flexible circuit board and the second wiring of the flexible circuit board.

In some exemplary embodiments, the first wiring of the flexible circuit board and the second wiring of the flexible circuit board are located in a same layer.

The exemplary embodiments described above, as well as the technical features mentioned in the exemplary embodiments, may be combined as appropriate to form different embodiments. The embodiments thus obtained do not depart from the spirit and scope of the disclosure.

### BRIEF DESCRIPTION OF DRAWINGS

FIG. 1 is a flowchart of a method for manufacturing a flexible touch screen provided by an exemplary embodiment of the present disclosure;

FIG. 2 is a schematic top view of a flexible substrate provided by an exemplary embodiment of the present disclosure;

FIGS. 3a-3g are used for illustrating a manufacturing process of a flexible touch screen provided by an exemplary embodiment of the present disclosure;

FIGS. 4a-4h are used for illustrating a manufacturing process of a flexible touch screen provided by another exemplary embodiment of the present disclosure.

### DETAILED DESCRIPTION OF EMBODIMENTS

Exemplary embodiments of the disclosure relate to a flexible touch screen and a manufacturing method thereof. In the process for manufacturing a flexible touch screen, a touch module and a flexible printed circuit (FPC) board are usually bonded to form a semi-finished product, and the semi-finished product is subjected to processes such as assembly and adhesion to form a final product. The inventors of the disclosed embodiments found that the bonding process for bonding the flexible circuit board to the touch module is prone to induce risks, for example, poor bonding may occur, and the flexible circuit board may even become detached from the touch module. Therefore, the reliability of the finally formed flexible touch screen needs to be improved.

Exemplary embodiments of a flexible touch screen and a manufacturing method thereof provided by the present disclosure will be described in more detail below with reference to the accompanying drawings and examples.

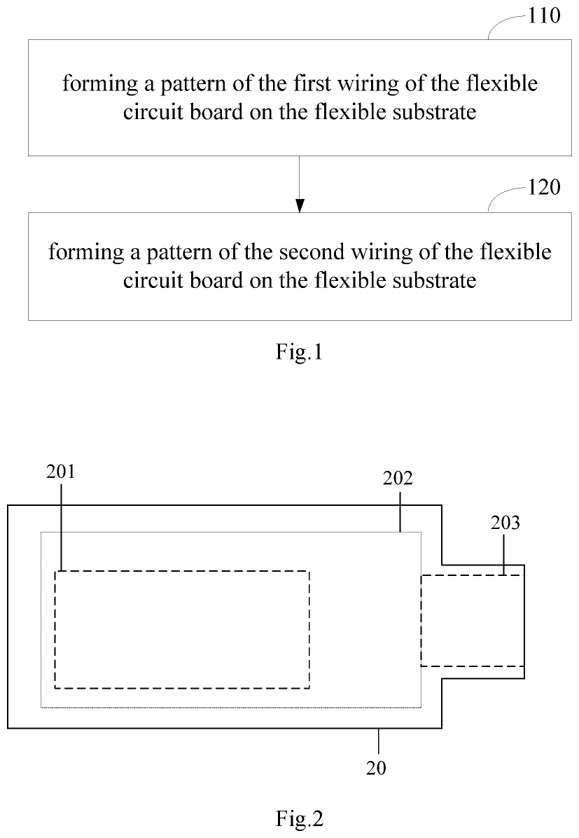

An exemplary embodiment of the disclosure provides a method for manufacturing a flexible touch screen. The method comprises forming, on a flexible substrate, patterns of a first touch electrode and a first connection line, and patterns of a second touch electrode and a second connection line. The second touch electrode and the first touch electrode form a capacitive touch structure. As shown in FIG. 1, the method for manufacturing a flexible touch screen further comprises: step 110, forming a pattern of a first wiring of the flexible circuit board on the flexible substrate; and step 120, forming a pattern of a second wiring of the flexible circuit board on the flexible substrate. The first touch electrode is electrically connected to the first wiring of the flexible circuit board via the first connection line, and the second touch electrode is electrically connected to the second wiring of the flexible circuit board via the second connection line, so as to realize signal transmission between the touch structure and the circuit in the flexible circuit board.

FIG. 2 schematically shows an exemplary top view of a flexible substrate 20. As shown in FIG. 2, the flexible substrate 20 has a touch area 201, a peripheral wiring area 202, and a flexible circuit board area 203. The first touch electrode and the second touch electrode are located in the touch area 201, the first connection line and the second connection line are located in the peripheral wiring area 202 outside the touch area 201, and the first wiring of the flexible circuit board and the second wiring of the flexible circuit board are located in the flexible circuit board area 203.

For the embodiments of the disclosure, the wirings for the flexible circuit board are directly formed on the flexible substrate 20 by means of a patterning process, and electrical connections between the touch electrodes, the touch electrode connection lines (e.g., first connection line, second connection line), and the flexible circuit board wirings are implemented, so that the touch structure of the flexible touch screen is integrated with the iii flexible circuit board thereof, thereby realizing the integration of the touch structure and the flexible circuit board. Therefore, there is no need to connect the touch structure to the flexible circuit board using a bonding process, thereby avoiding the risk of poor bonding resulting from the bonding process, and improving the reliability of the product. Moreover, the touch structure and the flexible circuit board are formed based on the same flexible substrate 20, which simplifies the product structure and saves the materials.

In an exemplary embodiment, in the above step 110, a specific implementation of forming a pattern of a first wiring of the flexible circuit board on the flexible substrate 20 using a patterning process may be: forming a pattern of a first wiring of the flexible circuit board and the patterns of the first touch electrode and the first connection line on the flexible substrate 20 by means of a same patterning process. The first touch electrode, the first connection line and the first wiring of the flexible circuit board as a whole is an integrative structure.

In this exemplary embodiment, the first touch electrode, the first connection line and the first wiring of the flexible circuit board are formed on the flexible substrate 20 by the same patterning process, thereby realizing formation of the touch structure and the flexible circuit board wirings at one time. Moreover, the first touch electrode, the first connection line and corresponding flexible circuit board wiring form an integrative structure, thereby simplifying the process flow and improving the production efficiency.

An example of the step 110 is illustrated above, and this step may be implemented in other different ways, which are not enumerated here.

It is to be noted that the solution of the above embodiment of the disclosure may be applicable to, but not limited to, a mutual capacitive touch process. In particular, it is applicable not only to a single-sided touch process, but also to a double-sided touch process. The single-sided touch process mentioned herein refers to a case where the second touch electrode and the first touch electrode are located on the same side of the flexible substrate 20, an insulating layer is disposed between the second touch electrode and the first touch electrode, and the second touch electrode and the first touch electrode together form a mutual capacitive touch structure with the insulating layer acting as a dielectric. The double-sided touch process mentioned herein refers to a situation where the second touch electrode and the first touch electrode are located on different sides of the flexible substrate 20, and the second touch electrode and the first touch electrode form a mutual capacitive touch structure, with the intermediate flexible substrate 20 acting as a dielectric. The solutions of other specific embodiments of the present disclosure continue to be described below by taking the single-sided touch process and the double-sided touch process as examples respectively.

In an exemplary embodiment, the step of forming patterns of the first touch electrode and the first connection line and patterns of the second touch electrode and the second connection line on the flexible substrate 20 may include: forming patterns of the first touch electrode and the first connection line on a side of the flexible substrate 20; forming a first insulating layer covering the patterns of the first touch electrode and the first connection line; forming patterns of the second touch electrode and the second connection line on the first insulating layer. During the patterning process for forming the patterns of the second touch electrode and the second connection line, the pattern of the second wiring of the flexible circuit board is formed simultaneously on the flexible substrate 20. The second touch electrode, the second connection line and the second wiring of the flexible circuit board are integrated. In this embodiment, the second touch electrode and the first touch electrode are insulated by the first insulating layer, and form a mutual capacitive touch structure. Since the second touch electrode, the second connection line and the second wiring of the flexible circuit board are simultaneously formed by means of a single patterning process, the touch structure and the flexible circuit board wirings are formed at one time, and the second touch electrode, the second connection line and the corresponding flexible circuit board wiring are integrated, further simplifying the process flow and improving the production efficiency.

Upon implementation, the manufacturing method provided by an embodiment of the present disclosure further comprises: forming a second insulating layer, the second insulating layer covering the pattern of the first wiring of the flexible circuit board, the patterns of the second touch electrode and the second connection line, and the pattern of the second wiring of the flexible circuit board; forming a first electrostatic shielding layer on the second insulating layer, an orthographic projection of the first electrostatic shielding layer on the flexible substrate 20 covering the pattern of the first wiring of the flexible circuit board and the pattern of the second wiring of the flexible circuit board.

In this exemplary embodiment, since an area where the flexible circuit board wirings reside is covered by the electrostatic shielding layer, an external interference signal can be shielded.

In another exemplary embodiment, the step of forming patterns of the first touch electrode and the first connection line and patterns of the second touch electrode and the second connection line on the flexible substrate 20 may include: forming patterns of the first touch electrode and the first connection line, and a pattern of the first wiring of the flexible circuit board on a first side of the flexible substrate 20 using a patterning process, and forming patterns of the second touch electrode and the second connection line on a second side of the flexible substrate 20 opposite to the first side. Accordingly, in the above step 120, forming a pattern of the second wiring of the flexible circuit board on the flexible substrate 20 using a patterning process may include: forming a pattern of the second wiring of the flexible circuit board using a patterning process on the first side of the flexible substrate 20 where the patterns of the first touch electrode and the first connection line are formed; forming a via hole in the flexible substrate 20 to achieve an electrical connection between the second touch electrode, the second connection line, and the second wiring of the flexible circuit board. In some embodiments, the inner wall of the via hole may be electrically conductive. Alternatively, in some embodiments, a conductive lead may be formed in the via hole to electrically connect the second connection line to the second wiring of the flexible circuit board.

In some exemplary embodiments, the pattern of the second wiring of the flexible circuit board may be formed while the patterns of the first touch electrode and the first connection line and the pattern of the first wiring of the flexible circuit board are being formed.

In this exemplary embodiment, the first touch electrode and the second touch electrode form a capacitive structure with a dielectric being the flexible substrate 20. Since the second touch electrode and the second connection line are on a different side of the flexible substrate 20 from the second wiring of the flexible circuit board, it is necessary to dispose a via hole in the flexible substrate 20 to achieve an electrical connection between the second wiring of the flexible circuit board and the second touch electrode.

In some exemplary embodiments, the manufacturing method further comprises: forming a third insulating layer, the third insulating layer covering the patterns of the first touch electrode and the first connection line, the pattern of the first wiring of the flexible circuit board, and the pattern of the second wiring of the flexible circuit board; forming a fourth insulating layer, the fourth insulating layer covering the patterns of the second touch electrode and the second connection line; forming a second electrostatic shielding layer on the third insulating layer, an orthographic projection of the second electrostatic shielding layer on the flexible substrate 20 covering the pattern of the first wiring of the flexible circuit board and the pattern of the second wiring of the flexible circuit board. In this exemplary embodiment, since an area to which the flexible circuit board wirings correspond is covered by the electrostatic shielding layer, an external interference signal can be shielded.

In the foregoing exemplary embodiments of the disclosure, the first wiring of the flexible circuit board and the second wiring of the flexible circuit board may be located in the same layer. Alternatively, they may also be located in different layers, which is not limited herein.

In another exemplary embodiment, the second wiring of the flexible circuit board and the first wiring of the flexible circuit board may be formed at different times. For example, the first wiring of the flexible circuit board is formed firstly, and in this case, the pattern of the first wiring of the flexible circuit board is shielded during the process of forming the pattern of the second wiring of the flexible circuit board. In this way, the formed first wiring of the flexible circuit board can be prevented from being affected when the second wiring of the flexible circuit board is being formed. Specifically, a photoresist pattern may be disposed on the first wiring of the flexible circuit board for shielding.

In some exemplary embodiments, the first touch electrode and the second touch electrode have a metal mesh structure to achieve a better flexibility effect. There are many types of metal materials, and the material of the metal mesh may be, but not limited to, copper or silver.

Based on the same concept, an exemplary embodiment of the present disclosure further provides a flexible touch screen comprising a flexible substrate 20; a first touch electrode, a first connection line, and a first wiring of a flexible circuit board located on the flexible substrate 20, and a second touch electrode, a second connection line, and a second wiring of the flexible circuit board located on the flexible substrate 20. The second touch electrode and the first touch electrode form a capacitive touch structure. The first touch electrode is electrically connected to the first wiring of the flexible circuit board via the first connection line, and the second touch electrode is electrically connected to the second wiring of the flexible circuit board via the second connection line so as to realize signal transmission between the touch structure and the circuit in the flexible circuit board.

In some exemplary embodiments, the first touch electrode, the first connection line, and the first wiring of the flexible circuit board form one-piece structure.

In some exemplary embodiments, the second touch electrode, the second connection line, the first touch electrode, the first connection line, the first wiring of the flexible circuit board, and the second wiring of the flexible circuit board are located on the same side of the flexible substrate 20, and the second touch electrode, the second connection line, and the second wiring of the flexible circuit board form one-piece structure. In some exemplary embodiments, the flexible touch screen further comprises a first insulating layer, a second insulating layer, and a first electrostatic shielding layer. The first insulating layer isolates the second touch electrode from the first touch electrode, and isolates the first connection line from the second connection line. The second insulating layer covers the first wiring of the flexible circuit board, the second touch electrode, the second connection line, and the second wiring of the flexible circuit board. An orthographic projection of the first electrostatic shielding layer on the flexible substrate 20 covers the first wiring of the flexible circuit board and the second wiring of the flexible circuit board.

Upon implementation, the first touch electrode, the first connection line, the first wiring of the flexible circuit board, and the second wiring of the flexible circuit board may be located on a first side of the flexible substrate 20, and the second touch electrode and the second connection line are located on a second side of the flexible substrate 20 opposite to the first side. The flexible touch screen further comprises a via hole disposed in the flexible substrate 20 for achieving an electrical connection between the second touch electrode, the second connection line, and the second wiring of the flexible circuit board. Additionally, the flexible touch screen further comprises a conductive lead disposed in the via hole in the flexible substrate 20 to further facilitate the electrical connection between the second touch electrode, the second connection line, and the second wiring of the flexible circuit board.

Upon implementation, the flexible touch screen may further comprise a third insulating layer, a fourth insulating layer and a second electrostatic shielding layer. The third insulating layer covers the first touch electrode, the first connection line, the first wiring of the flexible circuit board, and the second wiring of the flexible circuit board. The fourth insulating layer covers the second touch electrode and the second connection line. An orthographic projection of the second electrostatic shielding layer on the flexible substrate 20 covers the first wiring of the flexible circuit board and the second wiring of the flexible circuit board.

The flexible touch screen and the manufacturing method thereof provided by the exemplary embodiments of the disclosure will be described in more detail below with reference to the accompanying drawings.

In an exemplary embodiment, a flexible substrate 20 is firstly fabricated using, for example, a polyimide (PI) film or an amorphous cyclo-olefin polymer (COP) film; the flexible substrate 20 is prebaked at 50 degrees for 2 hours. Of course, the application does not impose a limitation on the material of the flexible substrate 20. Other flexible materials may also be used as the material of the flexible substrate 20.

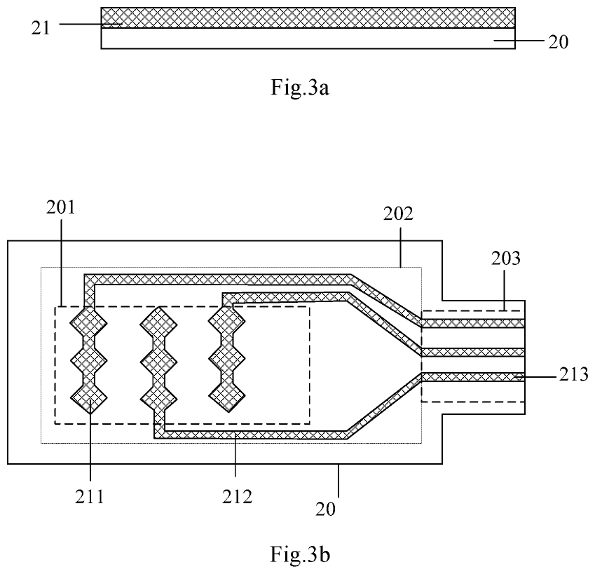

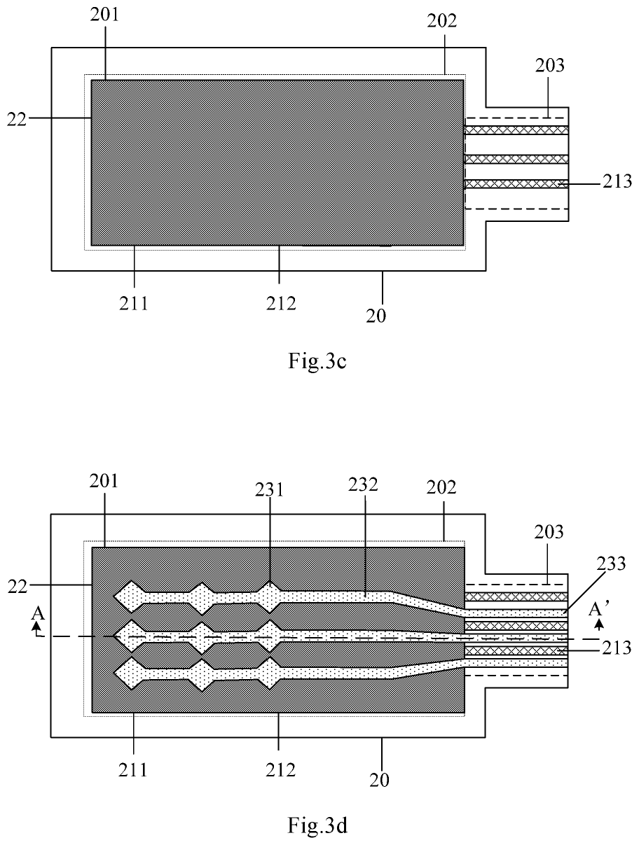

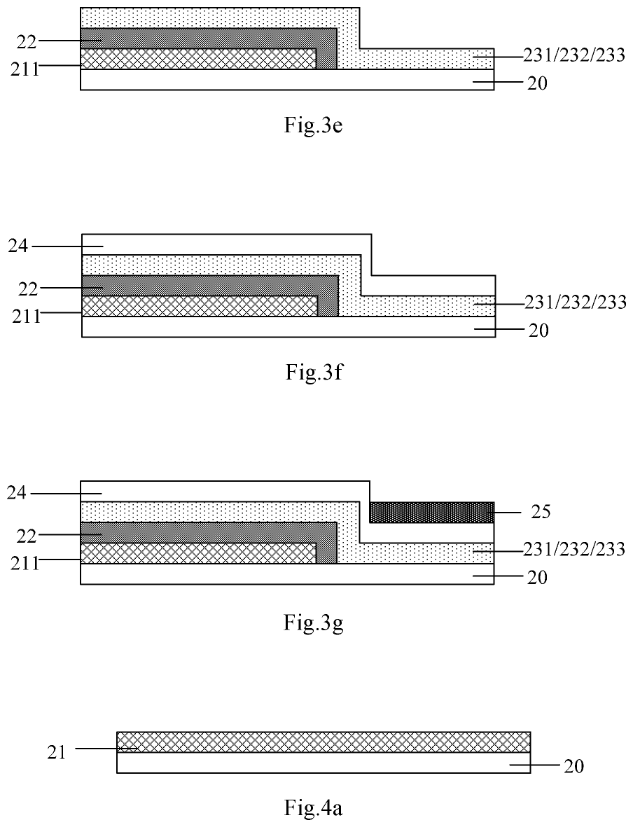

Then, as shown in FIG. 3a, a first metal thin film 21 is formed on the flexible substrate 20, and the first metal thin film 21 is etched according to a designed pattern using a photoresist and an etching solution such as aqua regia, as shown in FIG. 3b, forming a first touch electrode 211, a first connection line 212, and a first wiring 213 of the flexible circuit board which are integrated. The first touch electrode 211 may be a metal mesh structure.

In an exemplary embodiment, the first metal thin film 21 may be a copper film formed by magnetron sputtering using a copper target material. It may also be a silver film formed by magnetron sputtering using an APC target material.

In the next step, as shown in FIG. 3c, a first insulating layer 22 is formed for the patterns of the first touch electrode 211 and the first connection line 212 that has been formed using an OC adhesive.

Then, a photoresist pattern (not shown) that shields the first wiring of the flexible circuit board is formed, a second metal thin film is formed in the flexible circuit board area on the first insulating layer, and the second metal thin film is etched according to a designed pattern using a photoresist and an etching solution such as aqua regia, as shown in FIG. 3d, forming a second touch electrode 231, a second connection line 232, and a second wiring 233 of the flexible circuit board which are integrated. The second touch electrode 231 is a metal mesh structure. In the exemplary embodiment of FIG. 3d, the first wiring 213 of the flexible circuit board and the second wiring 233 are located in the same layer.

The second metal thin film may be a copper film formed by magnetron sputtering using a copper target material. It may also be a silver film formed by magnetron sputtering using an APC target material. The materials of the first metal thin film 21 and the second metal thin film may be the same or different.

For the structure shown in FIG. 3d, a sectional view thereof in the line AA′ is shown in FIG. 3e.

Next, as shown in FIG. 3f, a second insulating layer 24 is formed on the patterns of the second touch electrode 232 and the second connection line 233, and the patterns of the first wiring 231 of the flexible substrate 20 and the second wiring 213 (not shown) of the flexible substrate 20.

Then, as shown in FIG. 3g, a first electrostatic shielding layer 25 is formed on the second insulating layer 24 in the flexible circuit board area. The first electrostatic shielding layer covers a region of the second insulating layer 24 corresponding to the first wiring of the flexible circuit board and the second wiring of the flexible circuit board.

Based on the above steps, a flexible touch screen in which the touch structure and the flexible circuit board are integrated can be basically obtained.

In another exemplary embodiment, manufacturing a flexible touch screen may include the following steps.

First, a flexible substrate 20 is fabricated using a polyimide (PI) film or a cyclo-olefin polymer (COP) film; the flexible substrate 20 is prebaked at 50 degrees for 2 hours for later use.

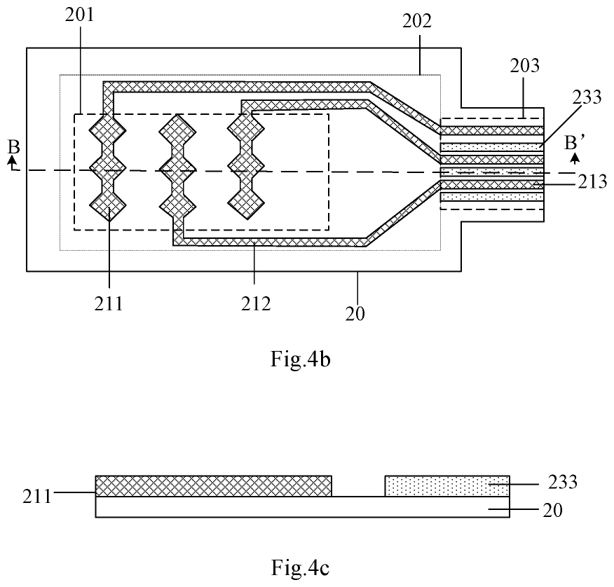

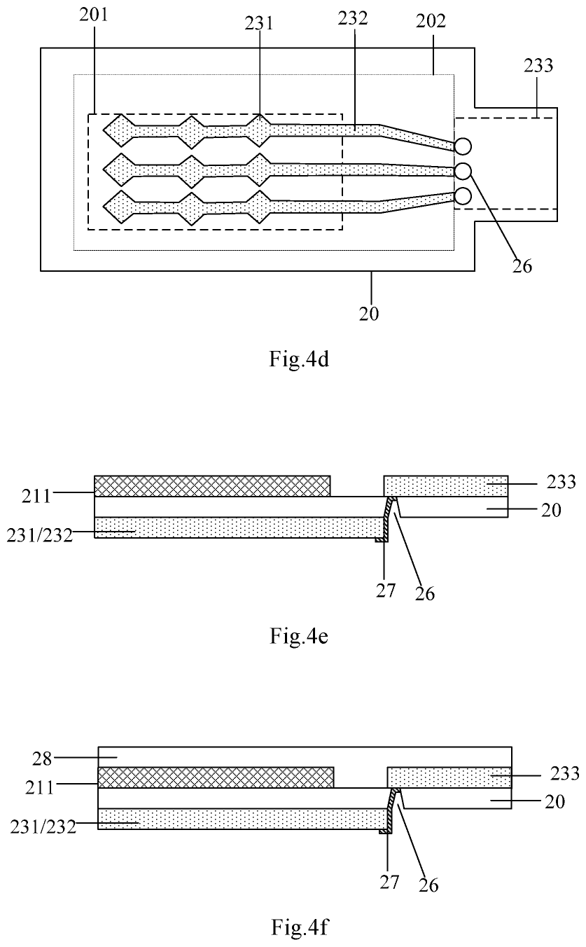

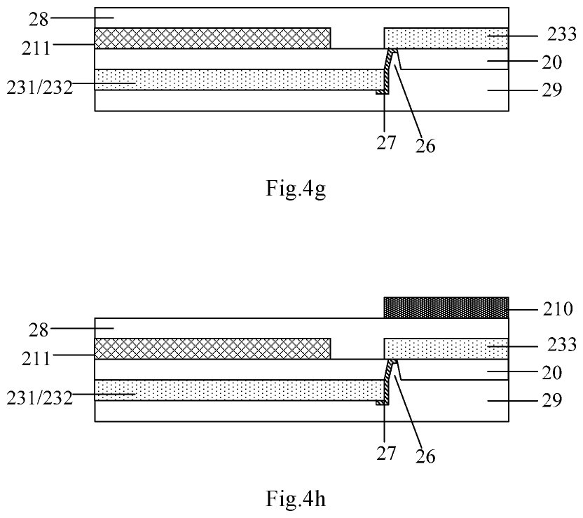

Then, as shown in FIG. 4a, a first metal thin film 21 is formed on the flexible substrate 20, and the first metal thin film 21 is etched according to a designed pattern using a photoresist and an etching solution such as aqua regia, as shown in FIG. 4b, forming patterns of a first touch electrode 211, a first connection line 212 and a first wiring of the flexible circuit board which are integrated, and also forming a pattern of a second wiring 233 of the flexible circuit board at the same time. The first touch electrode is a metal mesh structure.

In an exemplary embodiment, the first metal thin film 21 may be a copper film formed by magnetron sputtering using a copper target material. It may also be a silver film formed by magnetron sputtering using an APC target material.

For the structure shown in FIG. 4b, a sectional view thereof in the line indicated by BB′ is shown in FIG. 4c.

Next, as shown in FIG. 4d, a second metal thin film is formed on a side of the flexible substrate 20 where the pattern of the first touch electrode is not formed, and the second metal thin film is etched according to a designed pattern using a photoresist and an etching solution such as aqua regia, forming patterns of a second touch electrode 231 and a second connection line 232 which are integrated. Moreover, a via hole 26 is formed in the flexible substrate 20 for electrically connecting the second touch electrode 231, the second connection line 232 with the second wiring 233 of the flexible circuit board. In an example, a conductive lead 27 is further formed in via hole 26 as shown in FIG. 4e.

Then, as shown in FIG. 4f, an third insulating layer 28 is formed using an OC adhesive. The third insulating layer 28 covers the first touch electrode 211, the first connection line 212, and the first wiring 213 (not shown) of the flexible circuit board.

Then, as shown in FIG. 4g, a fourth insulating layer 29 is formed on the second touch electrode 231 and the second connection line 232.

Subsequently, as shown in FIG. 4h, a second electrostatic shielding layer 210 is formed in a region of the third insulating layer 28 corresponding to the flexible circuit board area. An orthographic projection of the second electrostatic shielding layer on the flexible substrate 20 covers the pattern of the first wiring of the flexible circuit board and the pattern of the second wiring of the flexible circuit board.

Through the steps of this embodiment, a flexible touch screen in which the touch structure and the flexible circuit board are integrated can be basically obtained.

For the flexible touch screen and the manufacturing method thereof provided by exemplary embodiments of the disclosure, corresponding flexible circuit board wirings are formed using a patterning process on the flexible substrate 20 on which the touch electrodes and the touch electrode connection lines are formed, and electrical connections between the touch electrodes, the touch electrode connection lines and the flexible circuit board wirings are implemented, so that the touch structure is integrated with the flexible circuit board, thereby realizing the integration of the touch structure and the flexible circuit board. Therefore, there is no need to connect the touch structure to the flexible circuit board using a bonding process, thereby avoiding the risk of poor bonding resulting from the bonding process, and improving the reliability of the product. Moreover, the touch structure and the flexible circuit board are formed based on the same flexible substrate 20, which simplifies the product structure and saves the materials.

Those skilled in the art can make various modifications and variations to the present disclosure without departing from the spirit and scope thereof. In this way, if these modifications and variations to the disclosure pertain to the scope of the claims of the application and equivalent technologies thereof, the present application also intends to encompass these modifications and variations.

In the claims, the wording “comprising” does not exclude other elements or steps not listed therein, and technical features in the singular form are not meant to exclude the plural. The mere fact that certain measures are recited in mutually different dependent claims does not indicate that a combination of these measures cannot be used to advantage.

1. A manufacturing method for a flexible touch screen, comprising:
forming, on a flexible substrate, patterns of a first touch electrode and a first connection line, and patterns of a second touch electrode and a second connection line, the second touch electrode and the first touch electrode forming a capacitive touch structure, wherein the method further comprises:
forming a pattern of a first wiring of a flexible circuit board on the flexible substrate;
forming a pattern of a second wiring of the flexible circuit board on the flexible substrate; and
wherein the first touch electrode is electrically connected to the first wiring of the flexible circuit board via the first connection line, and the second touch electrode is electrically connected to the second wiring of the flexible circuit board via the second connection line, so as to achieve signal transmission between the touch structure and a circuit in the flexible circuit board.

2. The manufacturing method according to claim 1, wherein the first touch electrode, the first connection line and the first wiring of the flexible circuit board are formed on the flexible substrate by a same patterning process, wherein the first touch electrode, the first connection line and the first wiring of the flexible circuit board are integrated.

3. The manufacturing method according to claim 1, wherein forming, on a flexible substrate, patterns of a first touch electrode and a first connection line and patterns of a second touch electrode and a second connection line includes:
forming patterns of the first touch electrode and the first connection line on a side of the flexible substrate;
forming a first insulating layer covering the patterns of the first touch electrode and the first connection line;
forming the patterns of the second touch electrode and the second connection line on the first insulating layer; and
wherein during a patterning process for forming the patterns of the second touch electrode and the second connection line, the pattern of the second wiring of the flexible circuit board is formed on the flexible substrate simultaneously, wherein the second touch electrode, the second connection line and the second wiring of the flexible circuit board are integrated.

4. The manufacturing method according to claim 3, wherein the method further comprises:
forming a second insulating layer covering the pattern of the first wiring of the flexible circuit board, the patterns of the second touch electrode and the second connection line, and the pattern of the second wiring of the flexible circuit board; and
forming a first electrostatic shielding layer on the second insulating layer, an orthographic projection of the first electrostatic shielding layer on the flexible substrate covering the pattern of the first wiring of the flexible circuit board and the pattern of the second wiring of the flexible circuit board.

5. The manufacturing method according to claim 1, wherein
forming, on a flexible substrate, patterns of a first touch electrode and a first connection line and patterns of a second touch electrode and a second connection line includes:
forming the patterns of the first touch electrode and the first connection line, and the pattern of the first wiring of the flexible circuit board on a first side of the flexible substrate;
forming the patterns of the second touch electrode and the second connection line on a second side of the flexible substrate opposite to the first side;
wherein the method further comprises:
forming the pattern of the second wiring of the flexible circuit board on the first side of the flexible substrate; and
forming a via hole in the flexible substrate to achieve an electrical connection between the second touch electrode, the second connection line and the second wiring of the flexible circuit board.

6. The manufacturing method according to claim 5, wherein the method further comprises:
forming a third insulating layer, the third insulating layer covering the patterns of the first touch electrode and the first connection line, the pattern of the first wiring of the flexible circuit board, and the pattern of the second wiring of the flexible circuit board;
forming a fourth insulating layer, the fourth insulating layer covering the patterns of the second touch electrode and the second connection line; and
forming a second electrostatic shielding layer on the third insulating layer, an orthographic projection of the second electrostatic shielding layer on the flexible substrate covering the pattern of the first wiring of the flexible circuit board and the pattern of the second wiring of the flexible circuit board.

7. The manufacturing method according to claim 6, wherein the first wiring of the flexible circuit board and the second wiring of the flexible circuit board are located in a same layer.

8. The manufacturing method according to claim 7, wherein the pattern of the first wiring of the flexible circuit board is shielded during a process of forming the pattern of the second wiring of the flexible circuit board.

9. The manufacturing method according to claim 1, wherein each of the first touch electrode and the second touch electrode has a metal mesh structure.

10. The manufacturing method according to claim 9, wherein a material of the metal mesh structure includes copper or silver.

11. A flexible touch screen, comprising:
a flexible substrate;
a first touch electrode, a first connection line, and a first wiring of a flexible circuit board on the flexible substrate;
a second touch electrode, a second connection line, and a second wiring of the flexible circuit board on the flexible substrate;
wherein the second touch electrode and the first touch electrode form a capacitive touch structure; and
wherein the first touch electrode is electrically connected to the first wiring of the flexible circuit board via the first connection line, and the second touch electrode is electrically connected to the second wiring of the flexible circuit board via the second connection line, so as to achieve signal transmission between the touch structure and a circuit in the flexible circuit board.

12. The flexible touch screen according to claim 11, wherein the first touch electrode, the first connection line, and the first wiring of the flexible circuit board are integrated.

13. The flexible touch screen according to claim 11, wherein the second touch electrode, the second connection line, the first touch electrode, the first connection line, the first wiring of the flexible circuit board, and the second wiring of the flexible circuit board are located on a same side of the flexible substrate; and
wherein the second touch electrode, the second connection line, and the second wiring of the flexible circuit board are integrated.

14. The flexible touch screen according to claim 13, wherein the flexible touch screen further comprises:
a first insulating layer, the first insulating layer isolating the second touch electrode from the first touch electrode, and isolating the first connection line from the second connection line;
a second insulating layer covering the first wiring of the flexible circuit board, the second touch electrode, the second connection line, and the second wiring of the flexible circuit board; and
a first electrostatic shielding layer on the second insulating layer; an orthographic projection of the first electrostatic shielding layer on the flexible substrate covering the first wiring of the flexible circuit board and the second wiring of the flexible circuit board.

15. The flexible touch screen according to claim 11, wherein the first touch electrode, the first connection line, the first wiring of the flexible circuit board, and the second wiring of the flexible circuit board are located on a first side of the flexible substrate, and the second touch electrode and the second connection line are located on a second side of the flexible substrate opposite to the first side; and
wherein the flexible touch screen further comprises a via hole in the flexible substrate for achieving an electrical connection between the second touch electrode, the second connection line, and the second wiring of the flexible circuit board.

16. The flexible touch screen according to claim 15, wherein the flexible touch screen further comprises:
a third insulating layer covering the first touch electrode, the first connection line, the first wiring of the flexible circuit board, and the second wiring of the flexible circuit board;
a fourth insulating layer covering the second touch electrode and the second connection line; and
a second electrostatic shielding layer on the third insulating layer, an orthographic projection of the second electrostatic shielding layer on the flexible substrate covering the first wiring of the flexible circuit board and the second wiring of the flexible circuit board.

17. The flexible touch screen according to claim 11, wherein the first wiring of the flexible circuit board and the second wiring of the flexible circuit board are located in a same layer.
